(19) United States
(12) Patent Application Publication
(10) Pub. No.: US 2013/0160475 A1
(43) Pub. Date: Jun. 27, 2013

(54) Refrigerated Case Defrost Water Drain

(71) Applicants: Sascha Vinz, Gensingen (DE); Sri Nugroho, Mainz Kastel (DE); Markus Schuster, Mainz (DE)

(72) Inventors: Sascha Vinz, Gensingen (DE); Sri Nugroho, Mainz Kastel (DE); Markus Schuster, Mainz (DE)

(73) Assignee: CARRIER CORPORATION, Farmington, CT (US)

(21) Appl. No.: 13/515,684

(22) PCT Filed: Dec. 15, 2010
(86) PCT No.: PCT/US10/60428

§ 371 Date: Jun. 13, 2012

Related U.S. Application Data
(60) Provisional application No. 61/302,749, filed on Feb. 9, 2010.

(51) Int. Cl. A47F 3/04; B23P 19/00; F25D 21/14

(52) U.S. Cl. CPC A47F 3/0482; F25D 21/14; B23P 19/00
USPC 62/247; 62/291; 29/428

(57) ABSTRACT

A refrigerated case (20) has a body (22). The body has a refrigerated compartment (24) and an air flowpath (100). The body includes a lower wall (156) below the air flowpath. A drain pipe (150) protrudes from the lower wall and has a lower outlet (166). A refrigerant air heat exchanger (72) is along a refrigerant flowpath and within the air flowpath. The body further includes a water trap vessel (152) having an upper end (176) secured to the base, a lower portion (174) surrounding the drain outlet, at least one vessel outlet (170) above the drain outlet, and a segmented rim flange. The body includes a plurality of features (240) engaging an underside of the flange along respective segments to vertically and laterally retain the water trap vessel and permit removal of the vessel via a rotation of the vessel.

### CROSS-REFERENCE TO RELATED APPLICATION

Benefit is claimed of U.S. Patent Application Ser. No. 61/302,749, filed Feb. 9, 2010, and entitled “Refrigerated Case Defrost Water Drain”, the disclosure of which is incorporated by reference herein in its entirety as if set forth at length.

### BACKGROUND

The disclosure relates to refrigerated cases. More particularly, the disclosure relates to evaporation of defrost water.

Refrigerated cases typically feature an evaporator along a recirculating air flowpath to/from the refrigerated compartment of the case. Water from the air condenses on the evaporator and may freeze. Resulting frost may accumulate on the evaporator and may, in turn, block the airflow. Accordingly, from time to time, a defrost mode is initiated. Exemplary defrost modes may include use of an external heating element (e.g., an electric resistance element) to heat the evaporator and melt the frost. Alternatively, warm refrigerant may be used (e.g., via running the compressor in reverse or using multi-way valves to direct warm refrigerant to the evaporator (which may then function as a condenser or gas cooler in such a defrost mode)).

The defrost operation produces melt water which may pass to a drain and be collected in a pan or other vessel. The melt water, in turn, is then encouraged to evaporate by heating (e.g., by exposure to warm refrigerant). Evaporation may further be facilitated via partial immersion of sponge elements in the accumulation in the vessel. The sponge elements wick water out of the vessel and expose them to air along a large surface area.

### SUMMARY

One aspect of the disclosure involves a refrigerated case comprising a body. The body has a refrigerated compartment and an air flowpath. The body includes a lower wall below the air flowpath. A drain pipe protrudes from the lower wall and has a lower outlet. A refrigerant-air heat exchanger is along a refrigerant flowpath and within the air flowpath. The body further includes a water trap vessel having an upper end secured to the base, a lower portion surrounding the drain outlet, at least one vessel outlet above the drain outlet, and a segmented rim flange. The body includes a plurality of features engaging an underside of the flange along respective segments to vertically and laterally retain the water trap vessel and permit removal of the vessel via a rotation of the vessel.

In various implementations, the air flowpath may extend from an inlet positioned to receive air from the compartment to an outlet positioned to discharge air to the compartment. The case may further comprise a refrigeration system comprising: said refrigerant flowpath; a compressor along the refrigerant flowpath downstream of the refrigerant air heat exchanger in a cooling mode of operation; a first refrigerant air heat exchanger being a heat rejection heat exchanger in the cooling mode and downstream of the compressor; said refrigerant air heat exchanger as a second heat exchanger and being a heat absorption heat exchanger in the cooling mode; and an expansion device along the refrigerant flowpath, downstream of the first refrigerant air heat exchanger and upstream of the second refrigerant air heat exchanger in the cooling mode. The water trap vessel may comprise a molded plastic. A plurality of slots may segment the flange and form the at least one vessel outlet. The plurality of features may comprise a plurality of threaded fasteners; and the body further may comprise an additional threaded fastener between a respective pair of said segments. The case may further comprise a heated drain pan below the vessel.

Another aspect of the disclosure involves a method for using the case. The method comprises installing the water trap vessel by: lifting the water trap vessel into place; and rotating the water trap vessel in a first direction about a central longitudinal axis of the drain pipe. The installing may be a re-installing and the method may further comprise, prior to the re-installing: removing the water trap vessel by rotating the water trap vessel opposite the first direction; lowering the water trap vessel; and cleaning the water trap vessel.

Another aspect of the disclosure involves a water trap vessel having: an upper end; a lower portion; at least one vessel outlet; and a segmented rim flange. The vessel may comprise a molded plastic. A plurality of slots may segment the flange and form the at least one vessel outlet. The segmented rim flange may have a circular perimeter portion.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a simplified view of a refrigerated case.

FIG. 2 is a simplified vertical front-to-back sectional view of the case of FIG. 1.

FIG. 3 is a schematic view of a refrigeration system of the case of FIG. 1.

FIG. 4 is an enlarged sectional view of a drain area of the case of FIG. 2.

FIG. 5 is a sectional view of a drain area of a baseline case.

FIG. 6 is a side view of a drain area.

FIG. 7 is a bottom view of the drain area of FIG. 6.

FIG. 8 is a sectional view of the drain area of FIG. 6; taken along line 8-8. .

Like reference numbers and designations in the various drawings indicate like elements.

### DETAILED DESCRIPTION

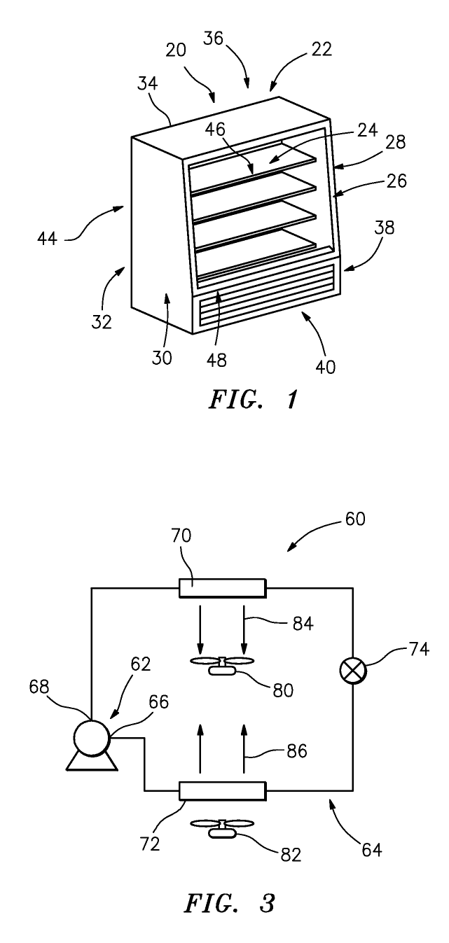

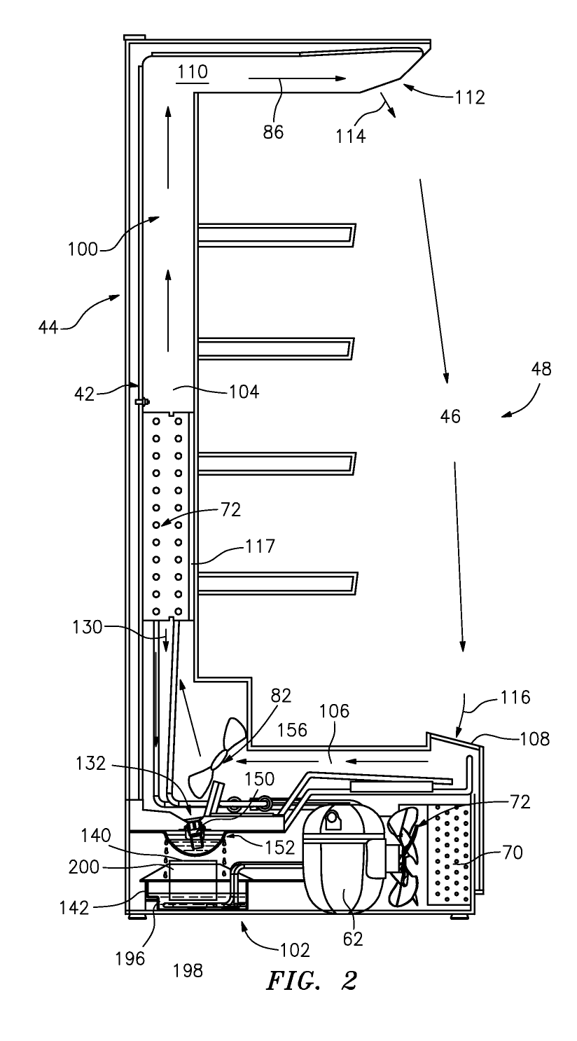

FIGS. 1 and 2 show a refrigerated case 20 having a body 22 at least partially enclosing a refrigerated compartment (interior) 24. The exemplary case/body is an open-front case having a left wall 26 at a left side 28, a right wall 30 at a right side 32, a top panel (wall) 34 at a top 36, a base 38 at a bottom 40, and a rear (back) panel 42 at a back (rear end) 44. An opening 46 extends at least partially along a front of 48 of the case. In the exemplary case, a vertical array of shelves 50 is positioned within the compartment 24.

The exemplary case 20 includes a refrigeration system 60 (FIG. 3). The refrigeration system comprises a compressor 62 along a refrigerant flowpath 64. The compressor has an inlet (suction port) 66 and an outlet (discharge port) 68. The refrigeration system includes a first refrigerant-air heat exchanger 70 and a second refrigerant-air heat exchanger 72. An expansion device 74 may be along the refrigerant flowpath 64 between the heat exchangers 70 and 72 opposite the compressor. Fans 80 and 82 may respectively drive airflows 84 and 86 across the heat exchangers 70 and 72.

In a cooling mode of operation, refrigerant compressed by the compressor exits the outlet 68 and proceeds to the first heat exchanger 70 which acts as a condenser or gas cooler (heating the air flow 84 to reduce the temperature of refrigerant as it flows through the first heat exchanger 70). Refrigerant proceeds downstream along the refrigerant flowpath 64 to the expansion device 74 where it is expanded and its temperature further reduced. The cold refrigerant enters the second heat exchanger 72 (which acts as an evaporator, absorbing heat from the airflow 86 and heating the refrigerant as it flows through the second heat exchanger 72). Refrigerant discharged from the second heat exchanger 72 returns to the compressor inlet 66. Other details, including accumulators, valves, and sensors may be present but are not shown for ease of illustration.

FIG. 2 shows further details of an air flowpath 100 and exemplary positioning of components of the refrigeration system 60. In the exemplary case 20, the compressor 62 and first heat exchanger 70 are positioned within a compartment 102 of the base 38. The second heat exchanger 72 is positioned within a rear duct 104 between the rear wall 42 and the compartment 24. The rear duct 104 extends from a base duct 106 at a lower end of the compartment which has an inlet 108 at a lower end of the front opening. The rear duct 104 feeds a top duct 110 which has an outlet 112. The flow 86 produces a discharge flow 114 from the outlet which may initiate/form an air curtain along the opening 46. Additional branching flows (not shown) may branch off the flow 86 and pass into the compartment 24. At least a portion of the flow 114 and any branching flows returns to the inlet 108 as an inlet flow 116. In the exemplary embodiment, the fan 82 is positioned proximate a junction of the rear duct 104 and base duct 106.

In a cooling mode, moisture in the inlet flow 116 may freeze on the heat exchanger 72 and may produce a frost accumulation which may lead to a blockage. Accordingly, a defrost mode may be initiated. Exemplary defrost may be via a heating element 117 (e.g., an electric resistance element) and/or via directing hot refrigerant to the heat exchanger 72 (instead of cold refrigerant). The defrost operation melts the frost which may flow downward as a flow 130 (e.g., of droplets) and reach a drain 132. An exemplary drain is formed proximate a lower end of the rear duct 104. The drain, in turn, discharges water as one or more flows 140 into an evaporation vessel 142. The exemplary drain 132 is formed by the combination of a drain pipe assembly 150 and a trap vessel 152. The drain pipe assembly 150 is mounted along a drain trough 154 along an upper surface of an insulated wall 156 forming a lower wall/boundary of the base duct.

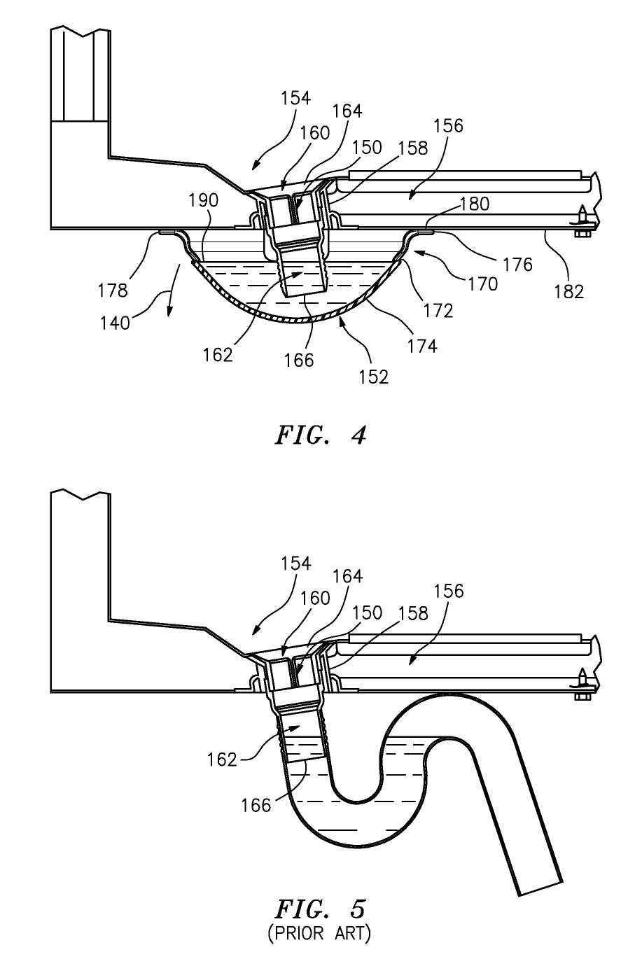

The exemplary assembly 150 (FIG. 4) is drawn from a prior art drain system (FIG. 5) wherein the outlet end portion is, in turn, secured to an S-pipe to form a trap. The exemplary drain pipe assembly 150 (FIG. 4) is a three-piece system comprising a first piece or member 158 as a molded plastic insert positioned during the manufacture of the wall 156. For example, the first piece 158 may be mounted to face sheets of the wall and foamed-in-place upon introduction of the wall's foam insulation. A respective upper piece 160 and lower piece 162 may be mated to each other through the first piece 158 (e.g., via snap fit or threaded engagement). The upper piece includes a flared inlet 156 of the drain assembly 150 at an upper end. The lower piece 162 includes an outlet 166 at a lower end. The outlet 166 is positioned within the trap vessel 152. The trap vessel 152 has a plurality of outlet apertures or ports 170, the lower extremities 172 of which are at a level/height above the uppermost level of the outlet 166 so as to form a trap. The exemplary trap vessel 152 is formed as a molded plastic (e.g., polyethylene) bowl-like shape extending from a lower bowl portion 174 to an upper flange 176 at a rim 178. The flange upper surface 180 is mounted against the lower surface 182 of the wall 156. In operation, the defrost water will accumulate in the vessel up to a level 190 at the port low extremities 172 whereupon it will form the flows 140. After flowing into the evaporation vessel 142 (e.g., a tray), the accumulated water 196, in turn, evaporates. Evaporation may be further encouraged by one or more of several means. There may be a heating element 198 in the tray which may be formed as part of the refrigerant line (e.g., the compressor discharge line) or may be an electric element. Wicking elements 200 (e.g., sponges) may be positioned to protrude out of the accumulation 196 and provide greater air exposure for the water.

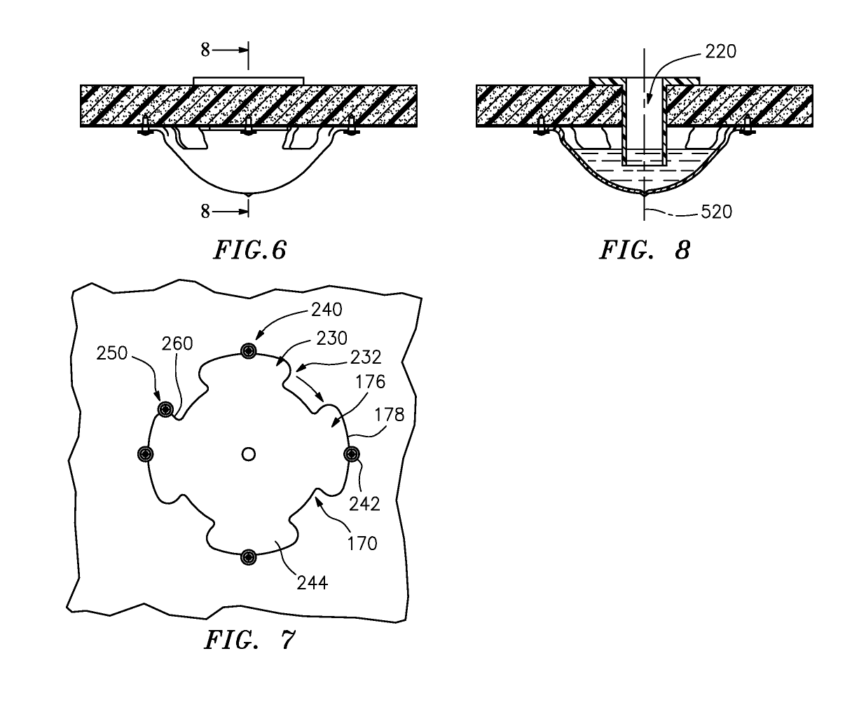

The exemplary trap vessel 152 may be manufactured in several stages: first there may be cutting or molding of a precursor (which may be flat or may have a shallow bowl shape) of an appropriate material. Then there may be a pressing/drawing process forming or deepening the bowl (e.g., as distinguished from an injection molding). Thereafter, the recesses may be machined (at least into the bowl portion). Further details of the trap vessel 152 and its installation are seen at FIGS. 6-8 which show a simplified vertical drain pipe 220 coaxial with the trap vessel along an axis 520. The exemplary flange 176 is initially molded as (or subsequently cut into) a segmented flange having an exemplary four segments 230 separated by gaps 232. The exemplary gaps 232 are coincident with the ports 170 and formed, in common, as a recess extending through the flange into the bowl portion 174. The rim 178 is circular along the intact portions of the flange.

The exemplary trap vessel 152 is secured to the wall 156 via a plurality of fasteners (e.g., threaded fasteners such as screws having washers). In the exemplary embodiment, an exemplary four screws 240 are positioned so that their shafts/shanks engage the rim 178 and the undersides of their heads engage (via washers 242) the underside 244 of the flange. These exemplary screws are positioned at equal radius from the axis 520 at exemplary 90° intervals. A fifth such screw 250 is positioned slightly radially inboard of the screws 240 to define a stop.

In manufacturing the case, the screws 240 and 250 may initially be installed (either to their final depths or slightly proud thereof). A template may be used to position the screws if the screws are self-drilling/tapping or alternatively, may be used to pre-drill holes. After exemplary screw installation, the trap vessel is raised into place in a broken line orientation (FIG. 7) wherein the screw heads/washers are accommodated by the gaps 232. Thereafter, the bowl may be rotated as at the axis 510. The rotation first causes capturing engagement of the flange by the screws 240 (e.g., along a circular perimeter portion of the flange) and is finally stopped by the abutting of a leading edge 260 of one of the intact portions of the rim with the shaft/shank of the screw 250. If the screws were not sufficiently inserted/tightened prior to this initial installation, the screws may then be sufficiently tightened. A first exemplary tightening is merely tight enough to hold the vessel in place but not interfere with a reverse rotation for removal. Alternatively, there may be sufficient tightening so that the screws need to be loosened to facilitate removal.

From time-to-time it may be desired to clean the trap vessel. The vessel 152 may be removed via first counter-rotating to the initial broken line (FIG. 7) orientation and then lowering the vessel. The vessel may be reinstalled as described above.

The deep drawing process may allow the bowl to be economically made. By way of contrast, JP2004353909 shows a more complex system wherein a molded trap vessel has a bayonet fitting engagement with a molded drain member. As is discussed above, engagement directly to the wall may also allow minimal changes when reengineering from a conventional S-trap configuration such as that shown in FIG. 5. Relative to such an S-trap configuration, use of a bowl-like trap can provide reduced height (thereby improving packaging efficiency) or can further facilitate cleaning. An exemplary trap vessel height is less than 80 mm (e.g., 70-80 mm).

Although an embodiment is described above in detail, such description is not intended for limiting the scope of the present disclosure. It will be understood that various modifications may be made without departing from the spirit and scope of the disclosure. For example, when implemented in the reengineering of an existing system configuration, details of the existing configuration may influence or dictate details of any particular implementation. Accordingly, other embodiments are within the scope of the following claims.

1. A refrigerated case (20) comprising:
a body (22) having:
a refrigerated compartment (24);
an air flowpath (100);
a lower wall (156) below the air flowpath; and
a drain pipe (150) protruding from the lower wall and having a lower outlet (166);
a refrigerant flowpath (64); and
a refrigerant-air heat exchanger (72) along the refrigerant flowpath and within the air flowpath,
wherein:
the body further comprises a water trap vessel (152), the water trap vessel having:
an upper end (176) secured to the base;
a lower portion (174) surrounding the drain outlet;
at least one vessel outlet (170) above the drain outlet; and
a segmented rim flange;
the body comprises a plurality of features (240) engaging an underside of the flange along respective said segments to vertically and laterally retain the water trap vessel and permit removal of the vessel via a rotation of the vessel; and
a plurality of slots both segment the flange and form the at least one vessel outlet.

2. The case of claim 1 wherein:
the air flowpath (100) extends from an inlet (108) positioned to receive air from the compartment and extending to an outlet (112) positioned to discharge air to the compartment

3. The case of claim 1 further comprising:
a refrigeration system (60) comprising:
said refrigerant flowpath (64);
a compressor (62) along the refrigerant flowpath downstream of the refrigerant-air heat exchanger in a cooling mode of operation;
a first refrigerant-air-heat exchanger (70) being a heat rejection heat exchanger in the cooling mode and downstream of the compressor;
said refrigerant-air heat exchanger as a second heat exchanger and being a heat absorption heat exchanger in the cooling mode; and
an expansion device (74) along the refrigerant flowpath, downstream of the first refrigerant-air heat exchanger and upstream of the second refrigerant-air heat exchanger in the cooling mode.

4. The case of claim 1 wherein:
the water trap vessel comprises a molded plastic.

5. (canceled)

6. The case of claim 1 wherein:
the plurality of features comprise a plurality of threaded fasteners (240); and
the body further comprises an additional threaded fastener (250) between a respective pair of said segments.

7. The case of claim 1 further comprising a heated drain pan below the vessel.

8. A method for using the case of claim 1, the method comprising:
installing the water trap vessel by:
lifting the water trap vessel into place; and
rotating the water trap vessel in a first direction about a central longitudinal axis of the drain pipe.

9. The method of claim 8 wherein the installing is a re-installing and the method further comprises, prior to the re-installing:
removing the water trap vessel by rotating the water trap vessel opposite the first direction;
lowering the water trap vessel; and
cleaning the water trap vessel.

10. A water trap vessel (152) having:
an upper end (176);
a lower portion (174);
at least one vessel outlet (170); and
a segmented rim flange,
wherein:
a plurality of slots both segment the flange and form the at least one vessel outlet.

11. The vessel of claim 10 wherein:
the water trap vessel comprises a molded plastic.

12. (canceled)

13. The vessel of claim 10 wherein:
the segmented rim flange has a circular perimeter portion.
